(19) United States
(12) Patent Application Publication
(10) Pub. No.: US 2026/0356582 A1
(43) Pub. Date: Nov. 12, 2026

(54) BEACON-BASED COMMUNICATION IN A HANGING-BAG WAREHOUSE PROVIDED WITH AT LEAST PARTIALLY AUTONOMOUSLY MOVING HANGING BAGS

(71) Applicant: EMHS GmbH, Pforzheim (DE)

(72) Inventors: Rene BRADE, Eppingen (DE); Dominik GEYER, Keltern (DE); Vincent David HERZOG, Konstanz (DE); Viktor HERZOG-LANG, Keltern (DE); Robin LUCKEY, Lübeck (DE); Frederic MÜLLER, Karlsruhe (DE); Kai PFISTER, Lübeck (DE); Felix THEURER, Pforzheim (DE)

(73) Assignee: EMHS GmbH, Pforzheim (DE)

(21) Appl. No.: 18/997,570

(22) PCT Filed: Jul. 21, 2023
(86) PCT No.: PCT/EP2023/070289

§ 371 Date: Jan. 22, 2025

(30) Foreign Application Priority Data
Jul. 22, 2022 (DE) 10 2022 002 691.0
Feb. 24, 2023 (DE) 10 2023 000 660.2

(51) Int. Cl. B65G 1/04

(52) U.S. Cl. CPC B65G 1/0457; B65G 2203/0208

(57) ABSTRACT

A hanging bag storage with at least partially autonomously or autonomously displaceable hanging bags comprises a network, on which a plurality of hanging bags can be displaced autonomously. The hanging bag storage comprises a high number of autonomously or at least partially autonomously displaceable hanging bags and communicates with the autonomously or at least partially autonomously displaceable hanging bags individually with a transmitting power density that is as low as possible and a data rate that is as high as possible. The hanging bag storage includes a control device by which the hanging bag storage can be controlled. A first communication configuration, using a communication path A can be set up between the control device and an addressee such as any individual one of the hanging bags, and a second communication configuration, using another communication path B, can be set up between the control device and the addressee.

### FIELD OF THE DISCLOSURE

The disclosure relates to a hanging bag storage equipped with traveling hanging bags, and a method for operating this hanging bag storage.

### BACKGROUND

In automated article storages, production facilities and during the transport of articles such as, for example, in the mail-order business, it is required to receive articles in article containers and unload articles from article containers in a manner that is as automated as possible. In these article containers, the articles can be stored before being delivered and will thus reach the station in which they are packaged for the onward transport to the customer. The transport inside the storages is usually executed by overhead conveying devices. Here, the article containers are mostly bags which are manufactured like fabric bags and are hooked into a rail system with a type of wire hanger at the top. Such an article container is known, for example, from WO 2014/012965 A1. A rod assembly is used to control the lateral wall elements of the article container such that the lateral wall elements, which are interconnected by a connection region, can be opened. In the region of a loading station, the containers are additionally brought into a horizontal or inclined position.

Comparable article containers and associated overhead conveying devices are known, for example, from DE 10 2004 018 569 A1, EP 2 130 968 A1 or EP 2 196 415 A. The transport bags described therein consist of flexible materials in the form of a loop, in which the article is held. For loading, these transport bags are opened from above in order to be able to insert the article into the loop. An unloading is done by the article being either removed or ejected sideways from the loop or the loop being opened downward, for example according to EP 2 130 968 A1. Further, an article carrier which has a relatively stiff and flat plastic wall with a cutout for loading and unloading articles is known from DE 103 54 419 A1.

Other article containers are manufactured like hanging, flat tubs of plastic which are unilaterally covered with elastic fabrics, whereby the article is wedged in.

It is known to load such article containers in a mechanized manner and unload them again manually. A transport cycle is determined by the slowest operation, which also depends on the quantity of transported articles. In particular a high number of individual articles can slow down the loading and/or unloading. For example, the unloading and/or the assembling of dismantled transport containers can determine the maximum possible transport cycle. EP 2 686 258 B1 relates to an overhead conveying system having a transport bag for the automated unloading of a loaded unit load and having an unloading station. The transport bag has a horizontal bottom on which the unit load can be stored for transport purposes. The bottom cooperates with a lifting device which is configured for lifting the bottom of the transport bag loaded with at least one unit load in a vertical direction when the transport bag is in an unloading position such that the at least one unit load can be centrally pushed out through an end face of a main body of the transport bag using a pushing device, wherein the pushing device comprises a slider which engages with an interior of the main body through a different end face of the main body where the at least one unit load is located when the bottom is lifted. This means that the two opposite, opened end faces, the bottom that is liftable in the vertical direction as well as the slider of the pushing device reaching through one of the end faces are required for unloading. Known from DE 20 2017 100 206 U1 is an article container for an overhead conveying device for transporting articles which can be adjusted between an opened position and a closed position. The article container has a bottom which is mechanically assigned to an ejection device. Using the ejection device, the bottom can be adjusted between a transport position, in which the article can be stored inside the article container, and an ejection position, in which the article can be ejected from the article container.

Known from DE 10 2018 105 795 A1 are a method for loading or unloading an article received on a flexible material of an article container using a station such as an unloading station and/or a loading station of an overhead conveying system, and an article container, unloading station and overhead conveying system according to the method. The article container is brought close to the station, where a force of attraction between the station and the article container for coupling the flexible material of the article container is then produced. The article container thus coupled is inclined and the article is ejected from the article container in a sliding motion.

DE 10 2018 128 417 A1 describes a method for transporting and sorting a sorter bag suspended on a roll adapter rolling on a rail network of a sorting plant for transporting a unit load, characterized by: provisioning the rail network of the sorting plant, provisioning the roll adapter of the sorter bag rolling on the rail network, provisioning an electrical drive energy for the roll adapter, converting the provisioned electrical drive energy to a kinetic energy for transporting the sorter bag using the roll adapter itself, and devices according to the method. The roll adapters serve to suspend and move the sorter bags. To that end, the roll adapters each comprise a chassis with two coaxially revolving wheels, a suspension arranged between the wheels and supported by the wheels on which the sorter bag is suspended, an electrical drive for driving the wheels and a control device or partial control device for autonomously or at least partially autonomously controlling the roll adapter along a travel path selected from a plurality of travel paths.

It is further known for industrial objects to communicate with one another according to a network standard, which is also referred to as the industrial internet of things (IIoT).

### Overview of the Disclosure

Starting from this prior art, the object underlying the present disclosure is, in a hanging bag storage comprising a high number of autonomously or at least partially autonomously displaceable hanging bags, to be able to communicate with these, in particular up to 1.5 million of the hanging bags, individually with a transmitting power density that is as low as possible and a data rate that is as high as possible, in particular to coordinate the plurality of autonomously displaceable hanging bags located in the hanging bag storage, preferably to control flows of storage articles received in the hanging bags with an effort that is as low as possible.

The object is achieved in a hanging bag storage for storing, picking, sorting and retrieving storage articles by a network, on which the plurality of hanging bags or hanging bags suspended on the roll adapters can be displaced autonomously or at least partially autonomously using the respectively cotraveling longitudinal and transverse dynamics control, a control device by which the hanging bag storage can be controlled and/or monitored and/or the storing, picking and sorting of the storage articles can be controlled and a sequence of the storage articles for a retrieval of the storage articles can be specified, a plurality of roll adapters and hanging bags suspendible or suspended on the roll adapters, wherein the roll adapters or the hanging bags each comprise a cotraveling longitudinal and transverse dynamics control and wherein at least one of the storage articles, respectively, can be received and retrieved again in the hanging bags, a first communication configuration, using which a communication path A between the control device and an addressee such as any individual one of the hanging bags can be set up, and a second communication configuration, using which another communication path B, which is independent of communication path A, can be set up between the control device and the addressee, wherein the hanging bags and/or roll adapters and/or the addressee can each be electively addressed, communicated with and/or controlled by the control device by and electively using one or two of the two communication paths A and B. The two independent communication paths ensure that overall more messages can be sent to and received by the hanging bags. The communication paths can be used flexibly and depending on a location of the respective hanging bag inside the hanging bag storage. This enables a transmitting power density to be minimized and a data rate to be maximized. This enables a particularly large number of hanging bags, preferably more than 10,000, in particular up to approximately 1,000,000, preferably up to 1,500,000, to be communicated with and controlled preferably with a density of up to 20, in particular between 10 and 20, hanging bags per meter during storage and/or when traveling in convoy. Once communicated with or issued an instruction respectively, the individual hanging bags can travel through the hanging bag storage autonomously or at least partially autonomously without any further messages. As soon as the instruction has been executed, there can be a low-wear and/or energy saving waiting phase/rest phase of the hanging bag communicated with and a new message with a new instruction can be sent and received by the addressee later or directly subsequently.

Preferably, it is possible for the communication paths A and B to comprise a hanging bag with a cotraveling first transceiving device configured for the communication path A and a cotraveling second transceiving device configured for the communication path B, a control device for centrally controlling the hanging bag storage, generating, sending and receiving messages via the communication paths A and B, a plurality of intermediate controllers, which are arranged downstream of the control device, preferably hard-wired, each equipped with an independent computing capacity and configured for the communication path A, a cluster of two to 10, preferably two to six, preferably four, beacons I, which is arranged downstream of one of the intermediate controllers, preferably hard-wired, and wherein the beacons I are each configured for the communication path A, a cluster of two to 10, preferably two to six, preferably three, beacons II, which is arranged downstream of one of the beacons I and wherein the beacons Il are each configured for the communication path A and/or a plurality of beacons III, which are arranged downstream of the control device, preferably hard-wired, and configured for the communication path B.

The cluster of the beacons I is preferably installed at the hanging bag storage, in particular at a peripheral region. This enables the hanging bags to be reached or addressed respectively in the entire hanging bag storage from the peripheral region into the interior with relatively short routes, in particular radio links. To that end, a selection of the corresponding one of the beacons I can be executed such that there is a distance that is as short as possible between the beacon I and the addressee. It is conceivable to provide the cluster of the beacons I as a module, in particular house it in a joint housing. A wiring effort can thus be saved. The further course of the respective communication path from the beacons I to the beacons II can be executed so as to be wireless using a route, in particular radio link, wherein the respective route can preferably always be established identically, so that a selection effort of the individual elements of the communication path A can be reduced. This means that it must merely be determined to which of the beacons II the addressee has the smallest distance. The communication path A then extends to that point, either directly or using any number of other ones of the hanging bags as intermediaries. The communication path from the respective beacon II to the central control device then extends along the preselected or preferably establishable route respectively to an assigned one of the beacons I and through the hard wires via the assigned intermediate controller and from there to the central control device.

Alternatively, it is conceivable, for reducing the transmitting power density even further, to communicate with very closely located hanging bags or addressees respectively directly with a route from the beacons I as an exception to the communicating using the respective assigned one of the beacons II.

Preferably, the beacons Il inside the hanging bag storage, in particular at traffic hubs, are arranged downstream of the respective beacon I, in particular according to a distance pattern, in particular so as to be distributed almost evenly or distributed evenly, inside the hanging bag storage, preferably via a radio link. The beacons II can be arranged, for example, at transitions or crossings respectively between regions in which the hanging bags are stored, i.e. moved little, to shunting routes, in which the hanging bags are sorted, and/or express routes, on which the hanging bags travel relatively quickly between the storage areas and an entry/exit or sorting device respectively and/or circular conveying plant.

It is possible to arrange the plurality of beacons III downstream of the control device so as to be hard-wired. The beacons III can also each be installed at the hanging bag storage, in particular at a peripheral region of the hanging bag storage. In contrast to the beacons II, the beacons III can be installed at the entries/exits or sorting device respectively and/or circular conveying plant and/or handover buffer. Using the beacons III, the communication required for a sorting operation and/or retrieval operation can take place locally and so as to be bundled and thereby be particularly resource saving, i.e. with a relatively low power density and high data rate.

Another preferred possibility is that the communication path A can be directed from the central control device to an addressed one of the hanging bags or to the addressee respectively via one of the intermediate controllers, one of the beacons I, one of the beacons II, or directly from one of the beacons I, using which a route to the addressee and/or to the beacon Il can respectively be set up, and/or a plurality of the hanging bags to the addressee, i.e. in particular to the addressed one of the hanging bags, and, independent of that, the communication path B can be directed from the control device via one of the beacons III to the addressee and/or simultaneously to another addressee, wherein the communication paths A and B have different communication protocols and/or routes. Data can be transmitted using two paths, wherein the routes used to that end can be kept particularly short in order to reduce the overall transmitting power density and thus also an electricity consumption of the hanging bag storage.

The intermediate controllers can be equipped with an independent computing capacity and are preferably hierarchically subordinate to the central control device. The intermediate controllers themselves can therefore take over tasks and unburden the central control device.

The beacons III can also be arranged downstream of the central control device and enter into a communication with the addressee via the route as soon as the addressee is within a range of the beacon III. The route can be a bidirectional transmitting/receiving route, wherein data can be transmitted to the central control device also by the addressee or by the corresponding hanging bag respectively.

In a particularly preferred exemplary embodiment, the hanging bag storage is designed for and/or comprises at least 100,000, preferably at least 500,000, in particular at least 750,000, at least 1,000,000, at least 1,500,000, preferably between 500,000 and 1,500,000, of the hanging bags, wherein the hanging bags can be electively addressed, communicated with and/or controlled by the control device by and using the two communication paths A and B. This enables the entire hanging bag storage to be controlled flexibly.

In another exemplary embodiment, the beacons I, the beacons Il and the hanging bags each comprise one of the first transceiving devices configured for the communication path A, which are optionally configured for receiving, sending or relaying messages, wherein a number of the transceiving devices used for transmitting an individual message via the communication path A is flexible. The communication path A can therefore be adapted to the location of the addressee inside the hanging bag storage, wherein a splitting into multiple individual routes can reduce the transmitting power over the entire distance in comparison to a single route, in particular radio link. A power of the individual transceiving devices can be designed so as to be relatively low and thus resource saving.

Further, it is conceivable that the intermediate controllers are arranged downstream of the control device so as to be hard-wired, the clusters of the beacons I are arranged downstream of the respective intermediate controller so as to be hard-wired, the clusters of the beacons II are arranged or arrangeable downstream of the respective beacon I using a preferably establishable one of the routes and the addressee can be addressed and/or communicated with using one of the beacons Il or from the beacon II using any number of other ones of the hanging bags. The communication between the control device and the addressee takes place preferably partially wired and partially using the route, in particular radio link. The partially wired communication additionally enables the transmitting power to be reduced to a minimum without having to relinquish the advantages of an individual radio communication with the hanging bags independent of the current location.

It can finally be provided that the beacons III and the second transceiving devices of the hanging bags have the Bluetooth Low Energy (BLE) standard and the communication path B can be established according to this standard. This can take place directly between the respective beacon III and the addressee. There can be a communication which is quick, limited to regions of the hanging bag storage and preferably bidirectional, in particular for special tasks such as sorting or storing and retrieving. Other tasks, such as the controlling of a simple relocating between two locations inside the hanging bag storage, in particular over longer distances, can take place using the communication path A, which, due to its high flexibility and range, can communicate with any addressee at any location inside the hanging bag storage. The communication path A can preferably be used for a waking up and rearranging of one of the hanging bags after a longer inactive phase, for example for a storage of a storage article or storing of the empty hanging bag.

It is also conceivable that immobile beacons II are provided in the hanging bag storage in addition to the cotraveling transceiving devices. The beacons II can preferably comprise transceiving devices which have identical structures or an identical or at least similar protocol respectively as the cotraveling transceiving devices. The beacons II can preferably be used for the communication between the respective beacons I and the respective beacon II. This has the advantage that the communication path A of the first channel can be set up optionally using a stationary radio link between the beacons I and the beacons Il or directly from one of the beacons I to one of the cotraveling transceiving devices. This means that it is not imperatively required to establish the communication path A via one of the beacons II. Optionally, one of the cotraveling transceiving devices of one of the hanging bags can also be radioed directly by one of the beacons I.

For a selection of the communication path A to be established, an artificial intelligence can be used. It is also conceivable to use existing systems and protocols for this purpose which are known as the industrial internet of things (IIoT). The intermediate controller can also comprise or be adapted to such a protocol respectively and be designed so as to communicate with the beacons I accordingly.

Using this communication path A, all hanging bags of the hanging bag storage can be addressed flexibly, preferably bidirectionally. Namely in order to send the hanging bags a message starting from the central controller, for example the route instruction, or in order to transmit a message in the opposite direction, for example to report congestion and/or a breakdown.

Particularly advantageously, a radio traffic and/or a transmitting power inside the hanging bag storage can be reduced by providing another channel or communication path B respectively at specific points, in particular at peripheries of the hanging bag storage, preferably in the region of retrieval devices, for example conveying plants, in particular circular conveying plants, conveying in a vertical direction. A communication need occurring there for the retrieval can in particular take place using a second radio system and/or using relatively short routes, for example over a few centimeters up to approximately 10 meters. Such technology is known, for example, by the term Bluetooth Low Energy, Bluetooth LE (BLE in short). It extends from a beacon III respectively bidirectionally to one of the hanging bags. Preferably, different messages in comparison to the first communication method can be exchanged with the hanging bags. However, it is also conceivable for reasons of simplification that at least the messages sent to the hanging bags such as the route directions are identical. This enables a complexity of the communication and an effort for the control of the hanging bags themselves to be reduced further.

As soon as one of the hanging bags reaches a reception range of one of the beacons III, in particular one of the conveying plants, a handshake can take place and the beacon III takes over the communication. The beacons III are preferably subordinate to the same central controller and can optionally comprise another independent control/computing capacity and a corresponding other protocol.

The communication can take place, preferably in the region of the entire hanging bag storage, using the communication path A, which can have a cooperative and highly flexible network or can respectively be set up using this network. This highly flexible network can have both stationary and moving participants, which is also known by the term Meshnet. Here, the participants can each be designed and/or configured as senders, recipients and as intermediaries for relaying a message. A multiple communicating with surrounding radio network participants is therefore optionally also possible. However, this Meshnet, in turn, can be hierarchically structured in itself in terms of the non-movable intermediate controllers subordinate to the central controller, the subordinate and permanently mounted beacons I and the also permanently mounted beacons II. As a particularity, the beacons II, while preferably being equivalent in terms of protocol, are stationary, so that the beacons II can have a prominent role in the flexible structuring of the connection paths, i.e. of the respective communication path A, which reduces a radio load without increasing a complexity of the system. To that end, the network can be designed so as to be self-learning and automatically identify non-moving participants and preferably use them to set up the connection. The hierarchy of the communication path A can therefore preferably be generated by a self-learning process or adaptation respectively.

A communication density inside the hanging bag storage can be automatically and dynamically adapted, for example a communication density and a traffic volume are usually relatively low in pure storage areas, as the storage articles are stored there without movement for multiple hours to days.

The communication path B can provide an additional relief by being used in regions with a high communication requirement, for example in conveying plants and sorting devices inside the hanging bag storage. To that end, the communication path B can have a radio channel or radio frequency respectively and/or radio standard deviating from the communication path A.

In the region of a conveying and/or sorting plant, there is an increased need for communication and traffic in a relatively small space, which can be easily managed using the second bidirectional protocol (BLE) of the second communication path B, whereby the highly flexible Meshnet of the first communication path A can advantageously be unburdened. What is more, an overall radio power of the hanging bag storage can be reduced. What is more, this enables time critical operations to be controlled better.

In one embodiment of the hanging bag storage, it can be provided that a density of the hanging bags and/or roll adapters on the network viewed in an x-direction and/or direction of travel and in case of a traveling in convoy or a storage in standstill, is up to 20 of the hanging bags, in particular between 10 and 20 of the hanging bags, per meter and/or the network comprises a plurality of travel paths with this density arranged in parallel viewed in a y-direction and/or z-direction, wherein the hanging bags and/or roll adapters and/or the addressee can each be electively addressed, communicated with or controlled by using the two communication paths A and B. A relatively large number of the storage articles can be stored, sorted and moved in a small space, wherein a radio power density can be kept so low despite the high density of hanging bags that a reliable addressing remains possible.

What is more, it is possible in an alternative that the communication path A can be set up over a first greater distance or over the first greater distance which extends in the region of the entire hanging bag storage and the communication path B can be set up over a second smaller distance or over the second smaller distance which extends in regions of the hanging bag storage with a high communication requirement and/or can be set up inside the hanging bag storage in conveying plants and sorting devices with the high communication requirement. This enables a communication adapted to the communication tasks occurring during autonomous traveling, storing, sorting and retrieving. This enables the radio power density to be kept low.

Further, it is conceivable that the communication path A has a highly flexible and/or self-learning Meshnet, and/or wherein a hierarchy of the communication path A can be adapted and/or generated by a self-learning operation. A programming and control effort for a routing can thereby be relinquished in addition.

Finally, it is alternatively or additionally possible that the communication paths A and B have different time responses, and/or the communication path A has a relatively slower time response than the communication path B, which time response is adapted to the storing and addressing at rest, and/or that the communication path B has a faster time response than the communication path A, which time response is adapted to the sorting or sorting and controlling in conveying plants and sorting devices with a high communication requirement inside the hanging bag storage. The communication tasks inside the hanging bag storage can be flexibly adapted to regions with a high communication requirement and simultaneously high requirements for the time response.

The object is furthermore achieved in a method for operating a hanging bag storage equipped with at least partially autonomously or autonomously displaceable hanging bags by at least partially autonomous traveling of the hanging bags and wireless, in particular partially wireless and partially wired, handing over of messages to the hanging bags for controlling the at least partially autonomous traveling using a communication path A and a communication path B independent thereof. The communication can take place in parallel, optionally and flexibly and/or task-specific on two channels and with a relatively high data rate and a relatively low transmitting power density. The method is preferably executed with a hanging bag storage described above. In this respect, this results in the advantages described above.

In a preferred embodiment of the method, a handshake is executed as soon as a respective one of the hanging bags is within a range of one of the beacons III and the control of the respective one of the hanging bags is taken over using the communication path B for executing a sorting operation, retrieval operation and/or storage operation of the hanging bag storage. The communication path A can be executed throughout the entire hanging bag storage, wherein the communication for the operation(s) can take place with the communication path B. To that end, the communication path B can take over in case of an approach, wherein the communication path B can be designed for relatively short distances, in particular according to a known industrial standard such as BLE. A handover can take place as soon as the respective hanging bag approaches one of the beacons III.

Alternatively or additionally, it is possible to use the respective cotraveling second transceiving devices of the hanging bags configured for the communication path B for regulating a travel dynamic, regulating a distance and/or avoiding collisions. To that end, hanging bags located in a vicinity inside the hanging bag storage or on a joint travel path can additionally contact one another using the communication path A and/or a protocol of the communication path B, preferably derive a mutual distance therefrom, in particular in order to make decisions on that basis as to which measures such as adapting a travel speed to one another and/or stopping to avoid a collision and/or traveling in convoy are required. Therefore, a second task can be fulfilled on the short distances. It is conceivable that the communication paths A and B are designed for different distances. Depending on the required distance, one of the communication paths A or B can be used. This enables a radio power density to be reduced further. An additional effort can be relinquished and/or an overload of one of the communication paths A or B be avoided. Further, it is conceivable that time responses of the communication paths A and B differ from each other, wherein the communication path B can have a time response adapted to the tasks or better time response respectively than the communication path A, for example for managing the tasks, in particular the longitudinal control.

The first channel or communication path A respectively can be used to send messages, for example such as a route instruction, from the central control device to individual hanging bags. These individual hanging bags then control at least partially autonomously a route on a network in order to reach a destination contained in the route instruction. This can be executed by the central control device via a plurality of subordinate intermediate controllers, from these each via a plurality of beacons I, and from these via transceiving devices, which interconnect network-like and act as intermediaries up to a specific addressed one of the hanging bags. The intermediate controllers can have an independent computing capacity.

The communication between the central control device, intermediate controller and the beacons I can be wired and the other communication can take place through the transceiving devices using a plurality of radio links which can be set up over short distances of a few meters, in particular maximally 100 meters, preferably maximally 20 meters. This enables a transmitting power to be kept and/or set up low and the then respectively actually realized communication path A of the first channel to be kept and/or set up flexible.

Preferably, the transceiving devices of the communication path A and/or B can cotravel with the hanging bags, i.e. the hanging bags and/or roll adapters can comprise the transceiving devices.

The same messages can be sent using communication paths A and B and preferably the information as to distance to the other hanging bags can additionally be obtained using the communication path B.

In this application, a beacon can be understood to mean an immobile signal fire which addresses traveling participants, in particular a transceiving device, which can set up a communication with the traveling hanging bags, in particular a bidirectional communication and/or Meshnet, preferably according to a BLE and/or IIoT standard. It can also be understood to mean a stationary transceiving device which relays messages and optionally amplifies messages in the sense of a relay station and/or repeater, i.e. enables a greater range with a relatively low overall transmitting power.

Using the communication path A, it is conceivable to send a message optionally to multiple of the hanging bags simultaneously or to only one of the hanging bags. To that end, the hanging bags which are to receive one of the messages together can have a joint identifier to which the joint message can be addressed. Similarly to the broadcasting principle, this enables individual messages and thus radio traffic to be saved.

Further advantages result from the subclaims as well as from the description of a preferred exemplary embodiment below.

### BRIEF DESCRIPTION OF THE FIGURES

Below, the disclosure is explained in more detail on the basis of an exemplary embodiment represented in the figures. These show:

FIG. 1 a schematic three-dimensional lateral oblique view from the top front of a hanging bag storage;

FIG. 2 a schematic lateral view of a hanging bag for the hanging bag storage shown in FIG. 1;

FIG. 3 a schematic three-dimensional lateral oblique view from the top on multiple of the hanging bags shown in FIG. 2 on a rail network;

FIG. 4 a view of a part of a level of the hanging bag storage shown in the preceding figures with a first and a second communication configuration for realizing two communication paths A and B;

FIG. 5 a partial view of the level represented in FIG. 4,

FIG. 6 a tree diagram of a hierarchical structure of the communication configurations of the hanging bag storage shown in the preceding figures,

FIG. 7 a partial view of the tree diagram shown in FIG. 6 with the communication path B; and

FIG. 8 a flow chart of a method for operating a hanging bag storage equipped with at least partially autonomously or autonomously displaceable hanging bags.

### DETAILED DESCRIPTION OF PREFERRED EXEMPLARY EMBODIMENTS

The disclosure will now be explained in more detail by way of example with reference to the enclosed drawings. However, the exemplary embodiments are only examples, which are not to limit the inventive concept to a particular configuration. Before describing the disclosure in detail, it should be noted that the disclosure is not limited to the respective components of the device and the respective method steps, as these components and methods may vary. The terms used here are merely intended to describe particular embodiments and are not used restrictively. If in addition the singular or indefinite articles are used in the description or in the claims, this also refers to the plural of these elements, unless the overall context unambiguously illustrates otherwise.

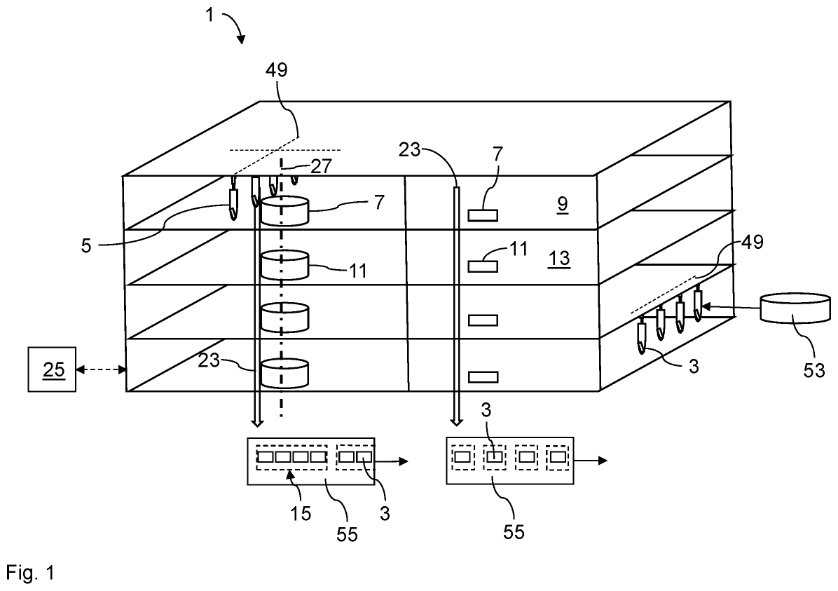

FIG. 1 shows a schematic three-dimensional lateral oblique view from the top front of a hanging bag storage 1.

The hanging bag storage 1 has at least two levels 9, 13, here a total of four, wherein a first level 9 and a second level 13 are provided with reference numbers by way of example. More or fewer levels are conceivable, for example 10 levels or more, which are arranged vertically on top of one another.

Each of the levels 9, 13 of the hanging bag storage 1 respectively have a handover buffer 7, 11, of which also only a first handover buffer 7 and a second handover buffer 11 are provided with reference numbers.

The hanging bag storage 1 serves to receive, store, sort and/or retrieve storage articles 3. Optionally as a pure storage or sorting device. The handover buffers 7, 11 are preferably arranged vertically on top of one another, which is symbolized by a line 27. However, it is also conceivable to arrange only at least two of the handover buffers 7, 11 on top of each other and/or arrange them obliquely to a perpendicular direction in space along the line 27.

Along the imaginary line 27 along which the handover buffers 7, 11 are arranged extends also a circular conveying plant 23, preferably a plurality of circular conveying plants 23. The handover buffers 7, 11 are arranged adjacent to the circular conveying plant 23 such that the storage articles 3 can be handed over into the circular conveying plant 23 by the handover buffers 7, 11 and/or can be stored in the levels 9, 13 or in the handover buffers 7, 11 of the levels 9, 13 respectively by the circular conveying plant 23.

In one exemplary embodiment, the storage articles 3 are handed over directly into the circular conveying plant 23. Preferably, the storage articles 3 are handed over into the circular conveying plant 23 while located in a hanging bag 5. Particularly preferably, there is an autonomous driving, controlling and/or moving of the entire hanging bag 5 before the provisioning, during the provisioning and/or handing over of the hanging bag 5. The method is in particular executed without trail chains. To that end, the hanging bag storage 1 is structured without trail chains for example at least in regions or entirely, preferably at least inside the levels 9, 13.

To that end, the hanging bag storage 1 has a network 49, for example a rail network with connecting sections and ramifications such as crossings and/or switches. Preferably, the network 49 is a grid with straight-lined rails that are interconnected by the crossings and/or switches, for example with rectangular network meshes.

To store the storage articles 3 in the hanging bag storage, the hanging bag storage has a handover point 53, at which the individual storage articles are handed over into individual hanging bags 5. Preferably, only respectively one of the storage articles 3 per hanging bag 5 is handed over. However, multiples ones are also conceivable, provided that there is sufficient space for them in the corresponding hanging bag 5. In the handover point, the storage articles 3 can optionally be buffered and handed over directly into the hanging bags, which travel toward the handover point 53 to that end and then travel onward, preferably autonomously, to a storage location of the hanging bag storage 1.

At an unloading station 55 of the hanging bag storage 1, the storage articles 3 are removed from the circular conveying plant 23 again and are available there, preferably in a specified or specifiable sequence 15. It is conceivable that a convoy of hanging bags 5, in the desired sequence 15, enter the unloading station 55 from the circular conveying plant 23 or are handed over into the unloading station 55 by the circular conveying plant 23 respectively, unloaded at the unloading station 55 and then travel back to be loaded again. The unloading station 55 can be arranged inside or outside one of the levels 9, 13, preferably in a lowest level.

However, it is alternatively also conceivable that the hanging bags 5 are conveyed using the circular conveying plant and unloaded at the unloading station 55 in the desired sequence and immediately transported back into the hanging bag storage 1 empty using the circular conveying plant 23, i.e. without the respective hanging bags 5 remaining in the unloading station or being available there, for example to travel or be transported onward to the handover point 53 after the unloading.

Particularly preferably, the hanging bags 5 are designed such that they travel autonomously on the network 49. Hanging bag storages 1 with autonomously traveling hanging bags 5 are known and described in DE 10 2018 128 417A1, for example, so that a detailed description is relinquished here. Preferably, a control device 25 is provided for a monitoring and controlling of the hanging bag storage 1, in particular for specifying the desired sequence 15 and controlling the circular conveying plant 23, which control device 25 exchanges information with the functional units of the hanging bag storage 1.

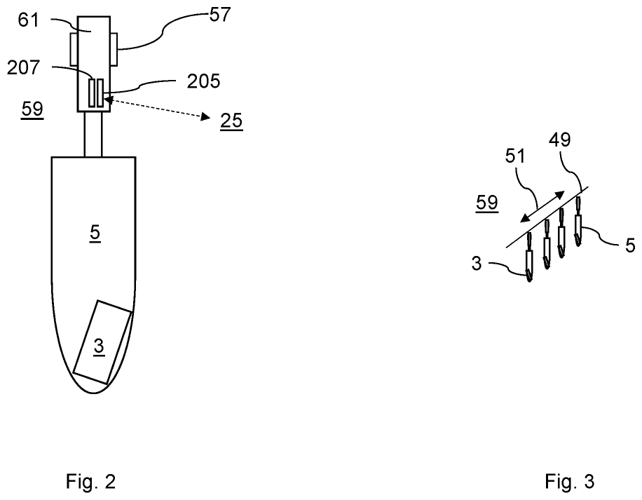

FIG. 2 shows a schematic lateral view of such a hanging bag 5 for the hanging bag storage 1 shown in FIG. 1, and FIG. 3 shows a three-dimensional view of multiple of the hanging bags 5 shown in FIG. 2, hooked into the network 49 for example designed as a rail network. To that end, the hanging bags 5 have wheels 57 and can be driven by a drive energy merely indicated by reference number 59 and by a drive using this drive energy. The hanging bags 5 can be configured having two parts and comprise a roll adapter 61 and a bag material, in particular flexible and/or foldable material, in which a storage article 3 can be received and which is or can be suspended respectively on the roll adapter 61 and released again, in particular nondestructively. In FIG. 3, a double arrow 51 indicates possible directions of motion of the hanging bags 5 in the network 49. The hanging bags 5, in particular their roll adapters 61, are configured, programmed and/or designed for the autonomous or partially autonomous traveling on the network 49. To that end, the hanging bags 5, in particular the roll adapters 61, can have the independent drive and an independent longitudinal and transverse dynamics control.

In FIG. 2, the hanging bag 5 is represented with a storage article 3 received therein. The storage article 3 is located inside a material, in particular flexible material, suspended in a U-shape. A loading and unloading can in particular take place from above or laterally.

Other than a drive, which is not represented in more detail, as well as a corresponding controller, the hanging bag 5 comprises a first transceiving device 205 and a second transceiving device 207. The first transceiving device 205 and second transceiving device 207 can be configured optionally individually or as an integrated component, preferably at least have different radio frequencies and/or transmission protocols.

The first transceiving device 205 and second transceiving device 207 enable the hanging bag 5 to receive or send messages with other hanging bags 5 and/or the control device 25 using two communication paths. This means that the messages can be handed over to or sent wirelessly by the other hanging bags 5 and/or the control device 25. This can optionally be executed using one of the transceiving devices 205 or 207, for example depending on a location inside the hanging bag storage 1 and/or on a current task of the respective hanging bag 5 such as storing, transporting, retrieving, depositing, buffering and/or sorting of the storage article 3.

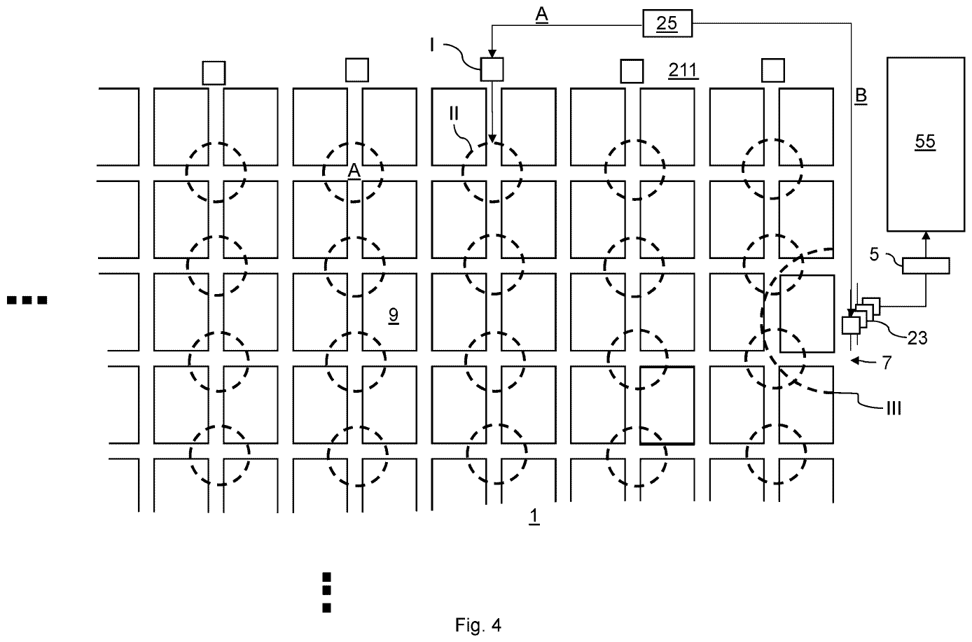

In FIGS. 4 to 7, the possible communication paths are described in more detail.

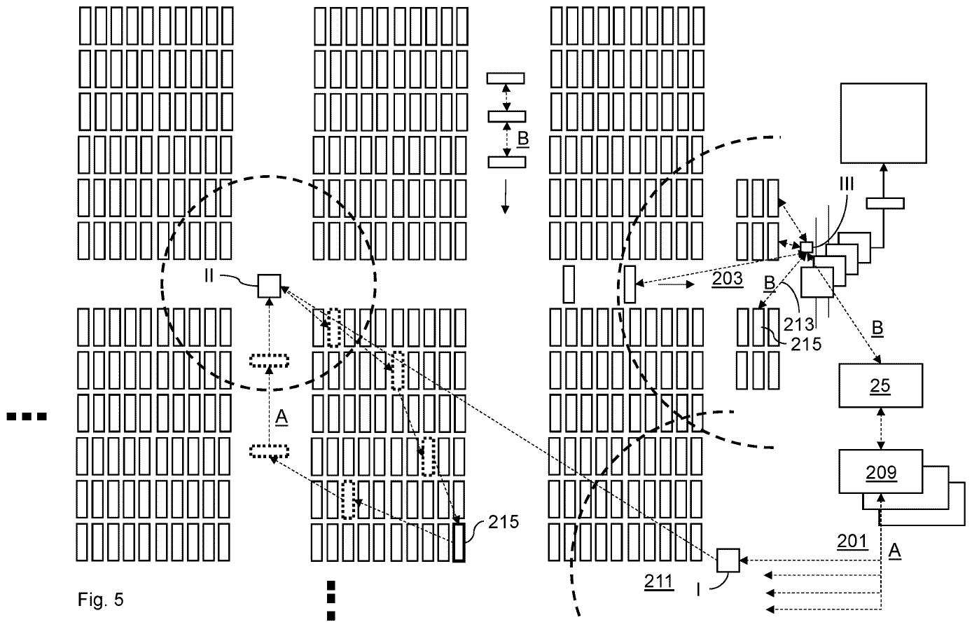

FIGS. 4 and 5 show a view of a part of the level 9 of the hanging bag storage 1 shown in the preceding figures, with two communication paths A and B. The remaining levels of the hanging bag storage 1 can be structured analogously, i.e. also comprise communication paths A and B.

The communication path A extends through a first communication configuration 201 from the central control device 25 via a plurality of intermediate controllers 209, a plurality of beacons I and a plurality of beacons II and/or individual ones of the hanging bags 5 located in the hanging bag storage 1 to an addressee 215. In this exemplary embodiment, the addressee 215 is also an addressed one of the hanging bags 5, for which the message 217 is intended, or by which the message is sent. One of the storage articles 3 can be received in the addressed one of the hanging bags 5 or in the addressee 215 respectively. For example, the communication path A can be used to send an instruction as to how to proceed with the storage article, in particular where the storage article is to be expected or transported respectively. These tasks can then be taken over by the hanging bag 5 itself.

The involvement of the hanging bags 5 themselves as intermediaries enables a Meshnet to be formed and each individual one of the hanging bags 5 to be electively communicated with. Particularly preferably, only a single storage article 3 is located in each of the hanging bags 5, so that the hanging bags 5 can be fetched individually. This enables a maximally flexible and quick handling and/or sorting. Preferably, the beacons II are permanently arranged at switches and the beacons I at peripheries 211 of the level 9. This enables a route formation for the communication path A to be simplified.

The communication path B extends from the central control device 25 through a second communication configuration 203 via a beacon III, using relatively short, preferably bidirectional, radio links, in particular of a few meters, in particular less than 10 meters, for example according to the BLE standard, to the addressee 215.

Preferably, the circular conveying plants 23 of the hanging bag storage 1 each comprise one of the beacons III per level 9, 13. This enables a retrieval, sorting and/or buffering as well as a handover from the level 9 into the circular conveying plant 23, i.e. preferably simultaneously a sorting of the hanging bags 5 and/or of the ones of the storage articles 3 received therein. It is possible to communicate with and thus coordinate all hanging bags 5 located within a range of the respective beacon III quasi simultaneously with time multiplexing after a handshake via respectively one route 213, preferably radio link. Corresponding messages from and to the respective addressee 215 may also contain instructions for a relocating to a new location inside the hanging bag storage 1. Preferably, identically structured messages 217 for coordinating the hanging bags 5 are transmitted using the communication paths A and B, so that the controllers of the hanging bags 5 merely process different transmission protocols of the communication paths A and B but can be designed for only one type of messages.

It is conceivable to use the communication path B also bilaterally between at least two of the hanging bags 5, i.e. without an involvement of the central control device 25. This additionally enables the transmitting power density in the hanging bag storage 1 to be reduced, as this task thereby does not run through the central control device 25.

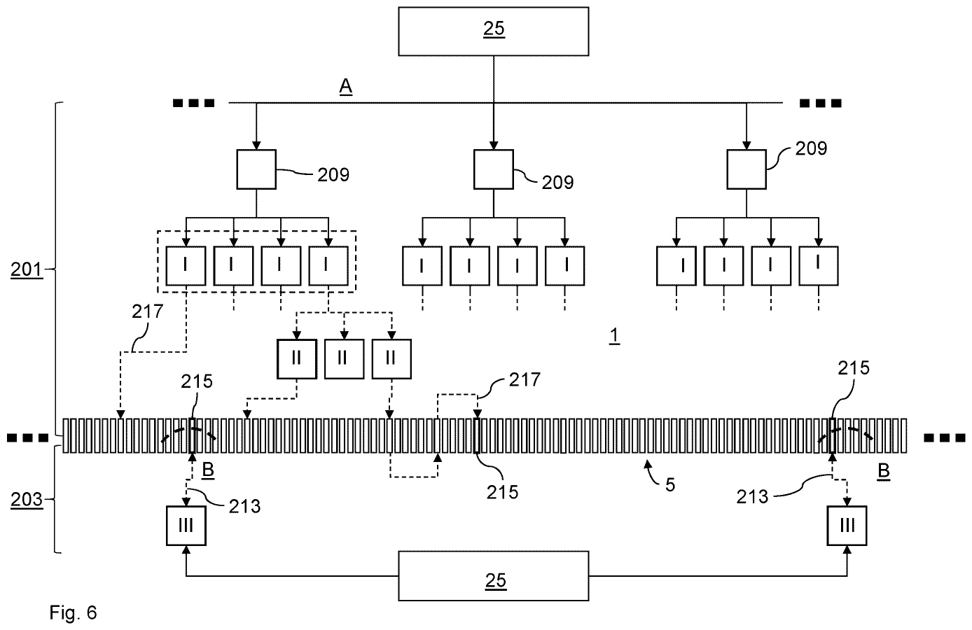

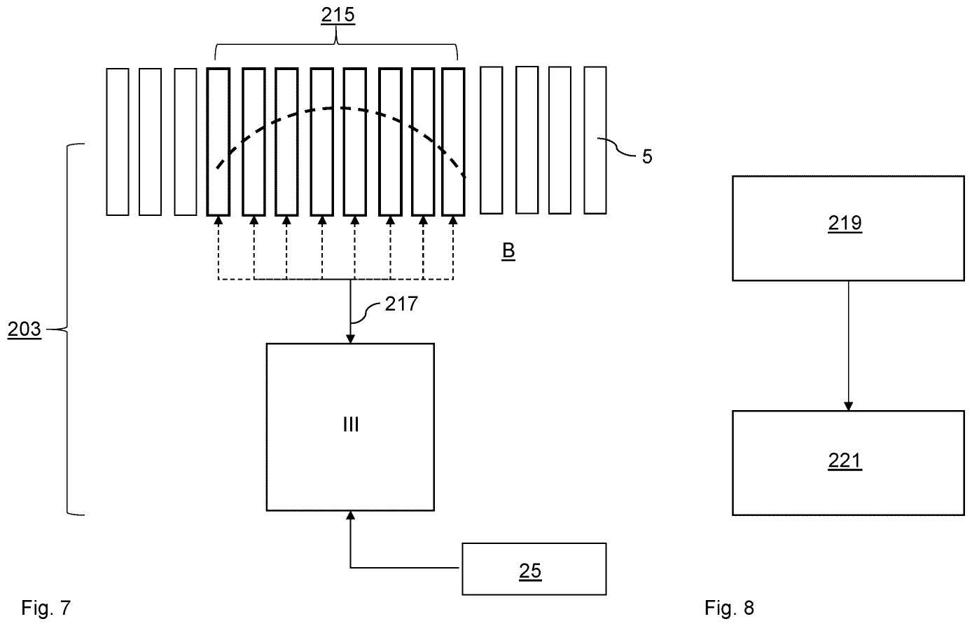

FIG. 6 shows a tree diagram of a hierarchical structure of the first and second communication configurations 201 and 203 to illustrate the thereby enabled communication paths A and B. FIG. 7 shows a partial view of the tree diagram shown in FIG. 6 with the communication path B.

In FIGS. 6 and 7, preferably hard-wired routes 213 are symbolized by solid lines and arrows and radio-based routes 213 by dashed lines and arrows.

The first communication configuration is segmented into five layers.

On a top first layer, the central control 25 is located, downstream of which a plurality of the intermediate controllers 209 is arranged.

The intermediate controllers 209 are interconnected, preferably in a wired manner, in a second layer, for example between two and 100 pieces, preferably approximately five pieces per level of the hanging bag storage 1. Preferably, the intermediate controllers 209 are equipped with an independent computing unit or computing capacity respectively. The independent computing unit and/or computing capacity can be configured as a standard component. Therefore, tasks for the route formation, new route formation if a formed communication path A is disrupted, and/or control of the communication in the intermediate controllers 209 can be outsourced in order to unburden the central control device 25.

In a third layer subordinate to the second layer, a plurality of the beacons I is arranged. Here, preferably four of the beacons I are arranged downstream of respectively one of the intermediate controllers 209. Here, it is possible that the four combined beacons I are accommodated in a joint housing, which is indicated in FIG. 6 by a dashed rectangle. Further, it is conceivable to also accommodate the respective intermediate controller 209 in the housing. This means that four of the beacons I can be communicated with per intermediate controller 209.

The third layer enables a plurality of subordinate beacons II to be communicated with per beacon I, which plurality of subordinate beacons II are arranged in a fourth layer to that end. The communication from the first layer to the third layer is preferably wired, wherein preferably the components of the first, second and third layers are mounted on the hanging bag storage 1, preferably at the peripheral region 211, so as to be stationary.

As another particularity, the beacons II of the fourth layer are preferably also installed in or on the hanging bag storage 1 so as to be stationary, preferably inside or at crossings, preferably at transitions between a storage area and routes, in particular shunting routes for rearranging the hanging bags 5 and/or express routes for a faster transporting of the hanging bags 5.

Although the beacons Il are preferably configured generally identically to each of the hanging bags 5 and the beacons I for setting up the respective communication path A, they are hierarchically arranged downstream of a particular one of the beacons I or are communicated with exclusively only by a particular one of the beacons I respectively. This takes place using the respective radio-based routes 213. The stationary assigning has the advantage that the route formation for the communication path A to one of the beacons Il is always specified according to the hierarchy of the layers one to four or specifiable by an algorithm so as to be dynamic and/or self-learning respectively. Preferably, the beacons and the hanging bags 5 are equipped with identical hardware units, wherein the respective function, in particular the routing of the messages 217, can be executed dynamically by a corresponding device and/or programming, in particular so as to be self-learning and/or self-optimizing. Therefore, any route of a message across the five layers is generally conceivable, however, useful routes will become apparent in the course of the use, which can then be used preferably and in particular extend via the stationary beacons I and II. Also, these routes can depend on a location of the addressee 215 but are then respectively identical per location in the course of the learning operation, which saves resources with respect to routing and enables optimized routes for the respective messages 217.

Only in a fifth layer is the route formation or the routing respectively for transmitting the message 217 completely free, in particular dependent on the respective location of the addressee 215 inside the hanging bag storage 1 per routing operation, and can be directed to the addressee 215 using any number of other ones of the hanging bags 5, which is marked by way of example for a message 217 in FIG. 6, wherein the message 217 is transmitted using two other ones of the hanging bags 5.

The segmentation of the first communication configuration 201 into a hard-wired part—layers one to three—a part comprising specified communication subroutes at least after a learning operation—layers one to four—and a part that is free in relation to the route formation—layer five—enables a particularly high number of the hanging bags 5 to be addressed at any location of the hanging bag storage 5 with a particularly low transmitting power density independent of location. Here, the transmitting power density is relatively low, as many short routes 213 are used and/or are structured partially hard-wired and partially flexibly for transmitting the respective message 217.

According to one possible alternative, it is conceivable to send messages directly from the third layer as required, i.e. from one of the beacons I directly to an addressee 215, i.e. directly to the fifth layer, bypassing the fourth layer, which is indicated on the left in FIG. 6. This can be limited to exceptions, in which the addressee 215 is located particularly close to one of the beacons l.

The second communication configuration 203 is subdivided into three layers, wherein the first layer also comprises the central control device 25, i.e. matches the first layer of the communication path A or of the first communication configuration 201 respectively.

Arranged downstream of the first layer or subordinate to the first layer respectively, a second layer of the second communication configuration 203 comprises at least one, preferably a plurality of the beacons III, in particular respectively one per circular conveying plant 23 per level 9, 13, for example between two and 100 pieces, preferably approximately 10 pieces per circular conveying plant 23.

The hanging bags 5 or the addressees 215 respectively are arranged in a third layer of the second communication configuration 203, wherein the third layer of the second communication configuration 203 matches the fifth layer of the first communication configuration 201.

The beacons III of the second layer of the second communication configuration 203 are arranged downstream of the control device 25 so as to be hard-wired. The hanging bags 5 and/or the addressees 215 are communicated with directly by the second layer as soon as the hanging bags 5 or the addressees 215 respectively are located within a range of the respective beacon III, which is indicated in FIGS. 6 and 7 by a partial circle line represented by dashed lines.

In FIG. 7, six of the hanging bags 5 are within the range of the beacon III by way of example, which is indicated by bold print. Here, the beacon III can communicate and exchange messages 217 with all six of the hanging bags 5 quasi simultaneously and/or in a time multiplexed manner.

FIG. 8 shows a flow chart of a method for operating a hanging bag storage equipped with at least partially autonomously or autonomously displaceable hanging bags.

In a first step 219, the hanging bags 5 are moved or displaced respectively at least partially autonomously or autonomously on the network 49. The messages 217 can comprise destinations for controlling the at least partially autonomous traveling, which can be handed over, preferably wirelessly, to the addressees 215 in a second step 221, which then travel partially autonomously or autonomously toward these destinations. The messages 217 can optionally be handed over using the communication path A or the communication path B independent thereof, in particular depending on a task and/or location in the hanging bag storage 1.

It is optionally conceivable to execute a handshake as soon as a respective one of the hanging bags 5 is within a range of one of the beacons III and take over the control of the respective one of the hanging bags 5 using the communication path B, in particular for executing a sorting operation, retrieval operation and/or storage operation of the hanging bag storage 1 using this communication path B.

Further, it is conceivable to use the second transceiving devices 207 of the hanging bags 5 configured for the communication path B additionally for regulating a travel dynamic, regulating a distance and/or avoiding collisions among one another.

It should be understood that this description may be subject to various modifications, alterations and adaptations which are within the range of equivalents of the appended claims.

### LIST OF REFERENCE NUMBERS

1 hanging bag storage
3 storage article
5 hanging bag
7 first handover buffer
9 first level
11 second handover buffer
13 second level
15 sequence
23 circular conveying plant
25 control device
27 line
49 network
51 double arrow
53 handover point
55 unloading station
57 wheels
59 drive energy
61 roll adapter
A communication path
B communication path
I beacon
II beacon
III beacon
201 first communication configuration
203 second communication configuration
205 first transceiving device
207 second transceiving device
209 intermediate controller
211 peripheral region
213 route
215 addressee
217 message
219 first step
221 second step

1. A hanging bag storage for storing, picking, sorting and retrieving storage articles, comprising:
a network, on which the plurality of hanging bags suspended on roll adapters can be displaced autonomously or at least partially autonomously each using a cotraveling longitudinal and transverse dynamics control,
a control device, by which the hanging bag storage can be controlled and/or monitored and/or the storing, picking and sorting of the storage articles can be controlled and a sequence of the storage articles for a retrieval of the storage articles can be specified,
a plurality of roll adapters and hanging bags suspendible or suspended on the roll adapters,
wherein the roll adapters or the hanging bags each comprise the cotraveling longitudinal and transverse dynamics control and wherein at least one of the storage articles, respectively, can be received and retrieved again in the hanging bags,
a first communication configuration, using communication path A between the control device and an addressee such as a random, individual one of the hanging bags can be set up,
a second communication configuration, using another communication path B, which is independent of the communication path A, can be set up between the control device and the addressee,
wherein the hanging bags and/or roll adapters and/or the addressee can each be electively addressed, communicated with and/or controlled by the control device by and electively using one or two of the two communication paths A and B.

2. The hanging bag storage according to claim 1, wherein the communication configurations comprise at least one or a plurality of elements from the following group:
a hanging bag and/or a roll adapter with a cotraveling first transceiving device configured for the communication path A and a cotraveling second transceiving device configured for the communication path B,
the control device, designed or configured for centrally controlling the hanging bag storage, generating, sending and/or receiving messages using the communication paths A and B,
a plurality of intermediate controllers, which are arranged downstream of the control device, each equipped with an independent computing capacity and configured for the communication path A,
a cluster of two to 10 beacons I, which is arranged downstream of one of the intermediate controllers and wherein the beacons I are each configured for the communication path A,
a cluster of two to 10 beacons II, which is arranged downstream of one of the beacons I and wherein the beacons I are configured for the communication path A,
a plurality of beacons III, which are arranged downstream of the control device and configured for the communication path B.

3. The hanging bag storage according to claim 1, wherein the communication path A from the control device to the addressee can be set up using:
an intermediate controllers,
a beacons I,
a beacons II,
or directly from one of the beacons I, using which respectively one route to the addressee and/or the beacon II can be set up, and/or
a plurality of the hanging bags
can be directed to the addressee and, independent of that, the communication path B can be directed from the control device via one of the beacons III to the addressee, wherein the communication paths A and B have different communication protocols and/or routes and/or radio frequencies.

4. The hanging bag storage according to claim 1, wherein the hanging bag storage is designed for and/or comprises at least 100,000 of the hanging bags, wherein the hanging bags and/or roll adapters and/or the addressee can each be electively addressed, communicated with and/or controlled by the control device by and using the two communication paths A and B.

5. The hanging bag storage according to claim 1, wherein a density of the hanging bags and/or roll adapters on the network viewed in an x-direction and/or direction of travel and in case of a traveling in convoy or a storage in standstill, is up to 20 of the hanging bags per meter and/or the network comprises a plurality of travel paths with this density arranged in parallel viewed in a y-direction and/or z-direction, wherein the hanging bags and/or roll adapters and/or the addressee can each be electively addressed, communicated with or controlled by the control device using the two communication paths A and B.

6. The hanging bag storage according to claim 1, wherein the beacons I, the beacons II and the hanging bags each comprise one of the first transceiving devices configured for the communication path A, which are configured for receiving, sending or relaying messages, wherein a number of the transceiving devices used for transmitting an individual message via the communication path A is flexible.

7. The hanging bag storage according to claim 1, wherein the intermediate controllers are arranged hardwired downstream of the control device, the clusters of the beacons I are arranged hardwired downstream of the respective intermediate controller, the clusters of the beacons II are arranged or arrangeable hardwired downstream of the respective beacon I using a preferably establishable one of the routes and the addressee can be addressed and/or communicated with using one of the beacons II or by the beacon II using any number of other ones of the hanging bags.

8. The hanging bag storage according to claim 1, wherein the beacons III and the second transceiving devices of the hanging bags use Bluetooth Low Energy (BLE) standard and the communication path B can be established according to this standard.

9. The hanging bag storage according to claim 1, wherein the communication path A can be set up over a first greater distance or over the first greater distance which extends in the region of the entire hanging bag storage and the communication path B can be set up over a second smaller distance or over the second smaller distance which extends in regions of the hanging bag storage with a high communication requirement and/or can be set up inside the hanging bag storage near conveying plants and sorting devices with the high communication requirement.

10. The hanging bag storage according to claim 1, wherein the communication path A has a highly flexible and/or self-learning Meshnet, and/or wherein a hierarchy of the communication path A can be adapted and/or generated by a self-learning operation.

11. The hanging bag storage according to claim 1, wherein communication paths A and B have different time responses, and/or the communication path A has a relatively slower time response than the communication path B, which time response is adapted to the storing and addressing at rest, and/or that the communication path B has a faster time response than the communication path A, which time response is adapted to the sorting or sorting and controlling in conveying plants and sorting devices with a high communication requirement inside the hanging bag storage.

12. A method for operating a hanging bag storage equipped with at least partially autonomously or autonomously displaceable hanging bags according to claim 1, comprising:
at least partially autonomous traveling of the hanging bags,
wireless handing over of messages to the hanging bags for controlling the at least partially autonomous traveling using a communication path A and a communication path B independent thereof.

13. The method according to claim 12, wherein:
executing a handshake as soon as a respective one of the hanging bags is within a range of one of the beacons III,
taking over the control of the respective one of the hanging bags using the communication path B for executing a sorting operation, retrieval operation and/or storage operation of the hanging bag storage.

14. The method according to claim 12, wherein:
using the second transceiving devices of the hanging bags and/or roll adapters configured for the communication path B for a travel dynamic control, a distance control and/or collision avoidance among one another and/or
additionally interconnecting the hanging bags and/or roll adapters using the communication path B and/or a protocol of the communication path B for the travel dynamic control, distance control and/or collision avoidance.

15. The method according to claim 12, wherein:
electively transmitting a message or transmitting a message using the communication path A to only one of the hanging bags and/or roll adapters and/or to the addressee or simultaneously to multiple of the hanging bags and/or roll adapters.

16. A hanging bag storage for storing, picking, sorting or retrieving storage articles, comprising:
a network, on which the plurality of hanging bags suspended on roll adapters can be displaced autonomously or at least partially autonomously each using a co-traveling longitudinal and transverse dynamics control,
a control device, by which the hanging bag storage can be controlled and/or monitored and/or the storing, picking and sorting of the storage articles can be controlled and a sequence of the storage articles for a retrieval of the storage articles can be specified,
a plurality of roll adapters and hanging bags suspendible,
a first communication configuration, using a communication path A between the control device and an addressee, and
a second communication configuration, using another communication path B, which is independent of the communication path A.

17. The hanging bag storage for storing, picking, sorting or retrieving storage articles, as claimed in claim 16, wherein the hanging bags and/or roll adapters and/or the addressee can each be electively addressed, communicated with and/or controlled by the control device.

18. The hanging bag storage for storing, picking, sorting or retrieving storage articles, as claimed in claim 16, wherein the hanging bag storage is configured to partially autonomously or autonomously displace hanging bags.

19. The hanging bag storage for storing, picking, sorting or retrieving storage articles, as claimed in claim 16, wherein the roll adapters or the hanging bags each comprise the co-traveling longitudinal and transverse dynamics control and wherein at least one of the storage articles can be received and retrieved again in the hanging bags.

20. A hanging bag storage for storing, picking, sorting and/or retrieving storage articles, comprising:
a network, on which the plurality of hanging bags suspended on roll adapters can be displaced autonomously or at least partially autonomously each using a co-traveling longitudinal and transverse dynamics control,
a control device, by which the hanging bag storage can be controlled and/or monitored and/or the storing, picking and sorting of the storage articles can be controlled and a sequence of the storage articles for a retrieval of the storage articles can be specified,
a plurality of roll adapters and hanging bags suspendible,
a first and a second communication configuration, wherein the communication configurations comprise at least one of the following:
a hanging bag, and/or a roll adapter with a cotraveling first transceiving device configured for a communication path A and a cotraveling second transceiving device configured for communication with a path B,
the control device, designed or configured for centrally controlling the hanging bag storage, generating, sending and/or receiving messages using the communication paths A and B,
a plurality of intermediate controllers, which are arranged downstream of the control device, each equipped with an independent computing capacity and configured for the communication path A,
a cluster of two to 10 beacons I, which is arranged downstream of one of the intermediate controllers and wherein the beacons I are each configured for the communication path A,
a cluster of two to 10 beacons II, which is arranged downstream of one of the beacons I and wherein the beacons I are configured for the communication path A,
a plurality of beacons III, which are arranged downstream of the control device and configured for the communication path B.
